(19) United States
(12) Patent Application Publication
(10) Pub. No.: US 2026/0082190 A1
(43) Pub. Date: Mar. 19, 2026

(54) PARALLEL INPUT/OUTPUT EXPANSION DEVICE FOR EQUIPMENT

(71) Applicant: CANTOPS CO., LTD., Gyeonggi-do (KR)

(72) Inventors: Youl Kwon SUNG, Gyeonggi-do (KR); Hak Seo OH, Gyeonggi-do (KR); Sung Hyuk YOUN, Incheon (KR); Hyeong Cheol CHOI, Gyeonggi-do (KR); Gi Myung CHO, Gyeonggi-do (KR)

(21) Appl. No.: 19/326,911

(22) Filed: Sep. 12, 2025

(30) Foreign Application Priority Data
Sep. 19, 2024 (KR) 10-2024-0126421

(51) Int. Cl. H04W 4/42; B61L 15/00

(52) U.S. Cl. CPC H04W 4/42; B61L 15/0018

(57) ABSTRACT

A parallel input/output expansion device for equipment includes:
a wireless communication device; a basic input/output device configured to generate output values for the plurality of ports based on data received from the wireless communication device via a serial interface, transmit the output values to each port, and transmit data collected from each port and data of a first port corresponding to identification information included in the received data to the wireless communication device; and a plurality of expansion input/output devices connected to each other through a serial interface and configured to transmit data of each port corresponding to the identification information included in the data received from the basic input/output device to the basic input/output device.

### BACKGROUND

The present invention relates to a parallel input/output expansion device for equipment, and more particularly, to a technology that enables the expansion of the equipment's parallel input/output device without the need for separate program development or protocol modification, thereby allowing flexible signal control of multiple ports within a wireless communication range through a single parallel input/output device, which facilitates installation work and reduces installation costs.

Generally, in manufacturing processes of a semiconductor element and a liquid crystal display device etc., the manufacturing goods are transmitted to the manufacturing equipment of each manufacturing process by using an automated material handling system (AMHS), so that the corresponding goods are manufactured according to the manufacturing processes of each manufacturing equipment. Such an automated material handling system utilizes a rail car for transmitting carriers of receiving a semiconductor substrate or a liquid crystal substrate to the manufacturing station located on the manufacturing process line according to a command from an upper level system (OCS) and transmitting the carrier of again receiving the goods completely processed in the corresponding manufacturing equipment to the next manufacturing equipment.

To transmit the carriers, the rail car communicates necessary data with the process equipment via a parallel I/O (PIO) interface, in accordance with the SEMI-E84 communication protocol and sequence, thereby enabling smooth carrier transfer and retrieval. The E84 protocol is a communication standard defined by SEMI (Semiconductor Equipment and Materials International) and is used for material handling communication between equipment.

The parallel input/output (I/O) devices can be classified as either infrared (IR) communication devices or radio frequency (RF) wireless communication devices, depending on the communication medium.

In the case of IR-based parallel I/O devices, the communication is only possible when alignment is maintained between the device installed on the rail car and the device installed on the process equipment, due to the characteristics of the IR medium.

In contrast, for the parallel input/output devices that use a wireless medium, the communication can still be established even when the alignment between the device installed on the rail car and the device installed on the process equipment is not accurate.

In many cases, process equipment is equipped with two or more ports, which are the positions where the rai car delivers the carriers. When multiple ports are installed on a single piece of process equipment and IR communication is used as the communication medium, an alignment between the communication devices is required. Accordingly, as shown in FIG. 1, in the case of equipment (200) having four ports (210), one parallel input/output device (220) is required for each port (210).

Furthermore, since the rail car (100) is larger than each port (210), for example, when the rail car (100) is communicating with Port 2 via the master parallel input/output device (110), the parallel input/output devices (220) of the adjacent ports (Port 1 and Port 3) cannot operate, which is a disadvantage.

When the wireless communication is used as the communication medium, a single parallel input/output device can be used for multiple ports. However, due to the SEMI-E84 communication standard, only two ports can be designated for signaling through the CS_0 and CS_1 terminals, which imposes a limitation on port expansion.

In addition, the equipment equipped with IR communication devices is programmed to use only the CS_0 signal among the E84 signals. Therefore, as shown in FIG. 2, it is possible to consider reducing costs by replacing the IR communication medium with a wireless communication medium (110) and utilizing both CS_0 and CS_1 signals so that a single parallel input/output device (220, 230) can control two ports. However, this also necessitates changes to the equipment program, which poses several procedural difficulties in practical application. Therefore, a method for expanding the parallel input/output devices of equipment that can overcome these limitations is required.

The applicant has previously proposed, in Korean Patent Registration No. 10-1749309, a data transmission method for an automated material handling system, wherein the master communication device (the rail car's communication device) configures unused signal terminals as port expansion signal terminals and the port control data is generated and transmitted to the slave communication device of the process equipment by using signals output from the port expansion signal terminals and the port selection signal terminals (CS_0, CS_1), thereby enabling the signal control of multiple load ports of the manufacturing equipment through a single slave communication device.

However, in the case of the applicant's prior registered patent, the port expansion method uses an NC signal (unused signal terminal) among the parallel signals, which causes an additional step in the rail car and the equipment to generate or delete the corresponding signal (port selection information) and transmit E84 data. In addition, since this signal is transmitted together with the E84 data, the SEMI E84 communication standard has been modified, resulting in a disadvantage where the rail car or the equipment of seeking expansion must develop an extended E84 communication protocol to be usable.

### Patent Literature

Patent Literature 1: Korean Patent Registration No. 10-1749309 (Data Transmission Method for Automated Material Handling System)

Patent Literature 2: Korean Patent Registration No. 10-0609297 (Optical Data Transmission Device)

Patent Literature 3: Korean Patent Registration No. 10-0292029 (Automated Material Handling System and Carrier Transfer Method)

### SUMMARY OF THE INVENTION

The present invention has been made in consideration of the problems described above and an object of the present invention is to efficiently expand parallel input/output devices without the need for separate communication protocol development.

According to an aspect of the invention to achieve the object described above, there is provided a parallel input/output expansion device for equipment including: a wireless communication device configured to set and wait with identification information corresponding to a plurality of ports provided in process equipment, to identify a port through which a communication is established when wireless communication is established with a parallel input/output device of a rail car, to transmit data received via the wireless communication with the parallel input/output device of the rail car to the corresponding port, and to transmit data collected from each port to the parallel input/output device of the rail car; a basic input/output device configured to generate output values for the plurality of ports based on data received from the wireless communication device via a serial interface, transmit the output values to each port, and transmit data collected from each port and data of a first port corresponding to identification information included in the received data to the wireless communication device; and a plurality of expansion input/output devices connected to each other through a serial interface and configured to transmit data of each port corresponding to the identification information included in the data received from the basic input/output device to the basic input/output device, wherein the wireless communication device transmits, via wireless communication, input data, that matches the port identification information, among the input data of the ports received through the basic input/output device to the parallel input/output device of the rail car.

According to another aspect of the invention to achieve the object described above, there is provided a parallel input/output expansion device for equipment including: a wireless communication device configured to set and wait with identification information corresponding to a plurality of ports provided in process equipment, to identify a port through which a communication is established when wireless communication is established with a parallel input/output device of a rail car, to transmit data received via the wireless communication with the parallel input/output device of the rail car to the corresponding port, to transmit data received from each port to the parallel input/output device of the rail car, and to collect data of a first port with identification information of the first port; and a plurality of expansion input/output devices connected with the wireless communication device via a serial interface and configured to transmit data of each port corresponding to identification information of each port included in the data received from the wireless communication device to the wireless communication device, wherein the wireless communication device transmits, via wireless communication, the input data that matches the port identification information among the input data of the first port and the input data of the ports received through the plurality of expansion input/output to the parallel input/output device of the rail car.

Here, the serial interface is any one of RS-232, RS-485, RS-422, I2C, SPI, USB, and CAN.

In addition, the identification information is any one of wireless identification information corresponding to the ports, channel information, and a tag number of a station where the rail car stops for operation.

In addition, the data received via wireless communication with the parallel input/output device of the rail car includes at least one of E84 data, additional information data, port identification information, and wireless communication establishment status information.

In addition, the parallel input/output device of the rail car performs control processing for the plurality of ports of the equipment within a wireless communication range with the wireless communication device.

In addition, during the data collection process, information collected from each port is transmitted in reverse order of the serial interface, from a terminal expansion input/output device to the basic input/output device, and then transmitted to the wireless communication device.

### BRIEF DESCRIPTION OF THE DRAWINGS

The above and other objects, features and advantages of the present invention will be more apparent from the following detailed description taken in conconfluence with the accompanying drawings, in which:

FIG. 1 illustrates a communication method between a master parallel input/output device and a slave parallel input/output device using an IR communication medium;

FIG. 2 illustrates a communication method between a master parallel input/output device and a slave parallel input/output device using an existing wireless communication medium;

FIG. 3 illustrates a method of communication between a master parallel input/output device and a slave parallel input/output device using a wireless communication medium according to the present invention;

FIG. 4 illustrates a connection example of the parallel input/output expansion device for equipment according to the present invention; and

FIG. 5 illustrates a connection example of a parallel input/output expansion device for equipment according to another embodiment of the present invention.

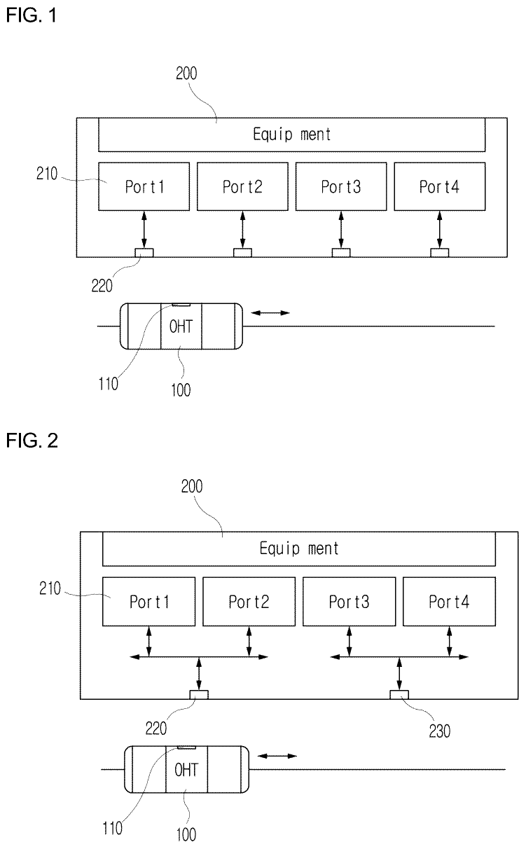

### REFERENCE SIGNS LIST

10: Rail car
11: Parallel input/output device
20: Equipment
21: Port
22: Wireless communication device
23: Basic input/output device
24, 25, 26: Expansion input/output device
30, 40, 50, 60: Interface

### DETAILED DESCRIPTION OF THE PREFERRED EMBODIMENT

The embodiments and configurations illustrated in the present invention and shown in the accompanying drawings are merely preferred embodiments of the invention, and do not represent the entirety of its technical spirit. Therefore, the scope of the present invention should not be interpreted as being limited by the embodiments and drawings described herein. That is, the embodiments are subject to various modifications and can take diverse forms, and thus the scope of the present invention should be understood to include equivalents that can realize its technical ideas.

Furthermore, the objectives or effects described in the present invention are not intended to suggest that any particular embodiment must achieve all such objectives or only those effects, and thus, the scope of the present invention should not be interpreted as being limited thereby.

Unless otherwise defined, all terms used herein shall have the same meanings as commonly understood by those skilled in the art to which the present invention pertains. Terms defined in general-purpose dictionaries shall be interpreted in a manner consistent with the contextual meaning in the relevant technical field, and shall not be construed in an idealized or overly formal sense unless explicitly defined otherwise in the present specification.

Hereinafter, a preferred embodiment of the present invention will be described in detail with reference to the accompanying drawings.

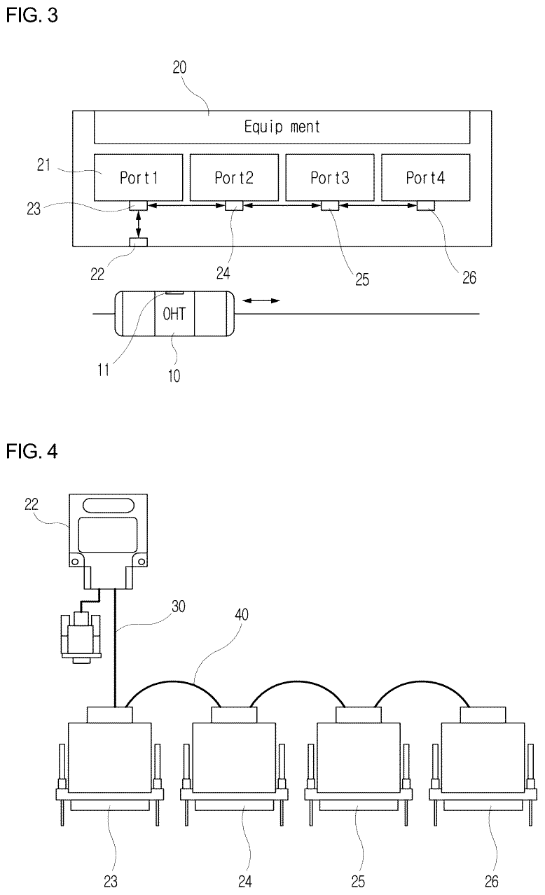

FIG. 3 illustrates a method of communication between a master parallel input/output device and a slave parallel input/output device using a wireless communication medium according to the present invention, and FIG. 4 illustrates a connection example of the parallel input/output expansion device for equipment according to the present invention.

Referring to FIG. 3 and FIG. 4, a parallel input/output expansion device for equipment according to the present invention includes a wireless communication device (22), a basic input/output device (23) connected thereto via an interface (30), and a plurality of expansion input/output devices (24, 25, and 26) connected to the basic input/output device (23) via an interface (40).

The basic input/output device (23) and the expansion input/output devices (24, 25, and 26) are connected in a cascade structure, and the interface has a direct serial signal communication structure.

Here, the interfaces (30 and 40) may be any serial interfaces such as serial communication, I2C, CAN, or serial INPUT/OUTPUT drivers and so on.

It is preferable that the basic input/output device (23) operates as a master controller, and the expansion input/output devices (24, 25, and 26) operate as slave controllers.

The wireless communication device (22) functions to transmit data received via wireless communication from a parallel input/output device (11) of a rail car (10) to the input/output devices (23-26) of the corresponding port, and to transmit data received from the input/output devices (23-26) of the ports to the parallel input/output device (11) of the rail car (10).

To this end, the wireless communication device (22) sets and waits with identification information corresponding to a plurality of ports, and, when the wireless communication is established with the parallel input/output device (11) of the rail car (10), it identifies the port through which the communication has been established (received). Each port's identification information may be any of a wireless ID, channel (CH) information, or a tag number of the station where the rail car stops for operation.

That is, the wireless communication device (22) holds identification information for each port and, while in a standby state for multiple wireless RFIDs, when the rail car (10) attempts wireless communication through a specific port, the data received from the corresponding port is ensured to be properly reflected.

The wireless communication device (22) transmits E84 data, additional information data, port information, and wireless communication establishment status information received from the parallel input/output device (11) of the rail car (10) to the basic input/output device (23) via the interface (30). It also transmits the input value of the port that matches the port information among the port input data received through the basic input/output device (23) to the parallel input/output device (11) of the rail car (10) via wireless communication. Here, the additional information data refers to process information that the logistics part and the manufacturing facility part, including the carrier ID, must share at the local level.

The basic input/output device (23) generates output values of ports 2 to 4 based on information (E84 data of the parallel input/output device (11) of the rail car (10), additional information data, port information, and wireless communication establishment status information) received from the wireless communication device (22) and transmits them to the expansion input/output devices (24, 25, and 26), while also performing the function as an input/output device of port 1. In addition, it collects the input data of port 1 and the input data of ports 2 to 4 received from the expansion input/output devices (24, 25, and 26) and transmits them to the wireless communication device (22).

The expansion input/output devices (24, 25, and 26) output port values received from the basic input/output device (23) through the interface, collect input values corresponding to each port, and transmit them to the basic input/output device (22) through the interface (40).

The process of communication between the rail car and the equipment via the parallel input/output expansion device of the present invention is as follows:

First, when there are four ports in one equipment, a wireless ID/CH is set for each port. In order for the rail car (10) to transmit a carrier to the equipment, the parallel input/output device (11) of the rail car (10) attempts wireless communication with the wireless communication device (22), and when wireless communication between the parallel input/output device (11) and the wireless communication device (22) is established, the parallel input/output device (11) transmits the port information (wireless ID/CH of the port) and E84 data to the wireless communication device (22).

Upon receiving the data from the parallel input/output device (11), the wireless communication device (22) transmits the received E84 data, the port information, and the wireless communication establishment status information to the basic input/output device (23) via the interface.

The basic input/output device (23) analyzes the data received from the wireless communication device (22), and if the received port information corresponds to the port 1, it outputs the port value corresponding to the port 1. If the received port information corresponds to the ports 2 to 4, it transmits the data received from the wireless communication device (22) to the expansion input/output devices (24, 25, and 26) via the interface.

Each expansion input/output device (24, 25, 26) analyzes the received data and outputs the received port value if the received port information is for its own port, and transmits the data to the next expansion input/output device if the received port information is not for its own port.

Through this process, the data transmission from the rail car (10) to the respective equipment ports (21) is completed.

Meanwhile, in the data collection process, the information collected from each port (21) is transmitted in reverse order through the interface from the expansion input/output devices (26, 25, and 24) to the basic input/output device (23), and then to the wireless communication device (22), which transmits the data to the rail car (10) via the wireless communication.

Thus, even without modification to the SEMI-E84 protocol, port expansion can be easily achieved via wireless communication, enabling a single parallel input/output device to access multiple ports of the equipment.

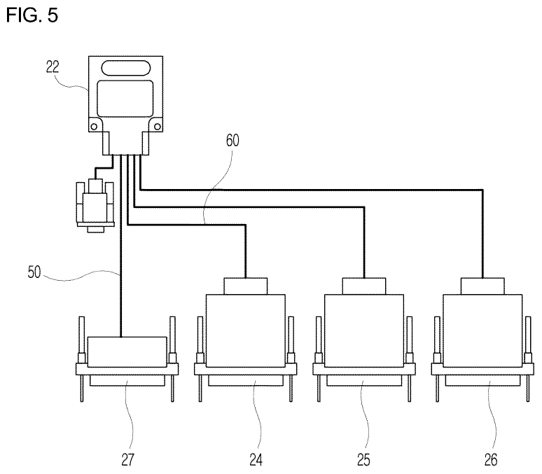

FIG. 5 illustrates a connection example of a parallel input/output expansion device for equipment according to another embodiment of the present invention.

In the embodiment of FIG. 5, the basic input/output device (23) of FIG. 4 is integrated into the wireless communication device (22), such that the wireless communication device (22) is connected to the connector (27) of the port 1 via an interface (50), and each of the expansion input/output devices (24, 25, and 26) is directly connected to the wireless communication device (22) via an interface (60).

In this embodiment, the interfaces (50, 60) may also be any serial interfaces such as serial communication, I2C, CAN, or serial INPUT/OUTPUT drivers.

The difference from the embodiment in FIG. 4 is that in this configuration, the wireless communication device (22) directly collects the data from the port 1 and the expansion input/output devices (24, 25, and 26) collect and transmit the data of the ports 2 to 4 to the wireless communication device (22) via their direct connection through the interface (60). According to the present invention, by installing only one parallel input/output device at the port section of the equipment, it is possible to freely control signals for a plurality of load ports within the range of wireless communication, thereby reducing the installation cost of communication devices.

Although the present invention has been described in connection with preferred embodiments, various modifications and alterations can be made without departing from the spirit and scope of the invention. Therefore, the appended claims should be construed as including such modifications and alterations that fall within the scope of the invention.

What is claimed is:

1. A parallel input/output expansion device for equipment comprising:
a wireless communication device configured to set and wait with identification information corresponding to a plurality of ports provided in process equipment, to identify a port through which a communication is established when wireless communication is established with a parallel input/output device of a rail car, to transmit data received via the wireless communication with the parallel input/output device of the rail car to the corresponding port, and to transmit data collected from each port to the parallel input/output device of the rail car;
a basic input/output device configured to generate output values for the plurality of ports based on data received from the wireless communication device via a serial interface, transmit the output values to each port, and transmit data collected from each port and data of a first port corresponding to identification information included in the received data to the wireless communication device; and
a plurality of expansion input/output devices connected to each other through a serial interface and configured to transmit data of each port corresponding to the identification information included in the data received from the basic input/output device to the basic input/output device,
wherein the wireless communication device transmits, via wireless communication, input data, that matches the port identification information, among the input data of the ports received through the basic input/output device to the parallel input/output device of the rail car.

2. The parallel input/output expansion device for equipment according to claim 1, wherein the serial interface is any one of RS-232, RS-485, RS-422, I2C, SPI, USB, and CAN.

3. The parallel input/output expansion device for equipment according to claim 1, wherein the identification information is any one of wireless identification information corresponding to the ports, channel information, and a tag number of a station where the rail car stops for operation.

4. The parallel input/output expansion device for equipment according to claim 1, wherein the data received via wireless communication with the parallel input/output device of the rail car includes at least one of E84 data, additional information data, port identification information, and wireless communication establishment status information.

5. The parallel input/output expansion device for equipment according to claim 1, wherein the parallel input/output device of the rail car performs control processing for the plurality of ports of the equipment within a wireless communication range with the wireless communication device.

6. The parallel input/output expansion device for equipment according to claim 1, wherein, during the data collection process, the information collected from each port is transmitted in reverse order of the serial interface, from a terminal expansion input/output device to the basic input/output device, and then transmitted to the wireless communication device.

7. A parallel input/output expansion device for equipment comprising:
a wireless communication device configured to set and wait with identification information corresponding to a plurality of ports provided in process equipment, to identify a port through which a communication is established when wireless communication is established with a parallel input/output device of a rail car, to transmit data received via the wireless communication with the parallel input/output device of the rail car to the corresponding port, to transmit data received from each port to the parallel input/output device of the rail car, and to collect data of a first port with identification information of the first port; and
a plurality of expansion input/output devices connected with the wireless communication device via a serial interface and configured to transmit data of each port corresponding to identification information of each port included in the data received from the wireless communication device to the wireless communication device,
wherein the wireless communication device transmits, via wireless communication, the input data that matches the port identification information among the input data of the first port and the input data of the ports received through the plurality of expansion input/output devices to the parallel input/output device of the rail car.

8. The parallel input/output expansion device for equipment according to claim 7, wherein the serial interface is any one of RS-232, RS-485, RS-422, I2C, SPI, USB, and CAN.

9. The parallel input/output expansion device for equipment according to claim 7, wherein the identification information is any one of wireless identification information corresponding to the ports, channel information, and a tag number of a station where the rail car stops for operation.

10. The parallel input/output expansion device for equipment according to claim 7, wherein the data received via wireless communication with the parallel input/output device of the rail car includes at least one of E84 data, additional information data, port identification information, and wireless communication establishment status information.

11. The parallel input/output expansion device for equipment according to claim 7, wherein the parallel input/output device of the rail car performs control processing for the plurality of ports of the equipment within a wireless communication range with the wireless communication device.
